(19) United States
(12) Patent Application Publication
(10) Pub. No.: US 2006/0288417 A1
(43) Pub. Date: Dec. 21, 2006

(54) Method and apparatus for mitigating the effects of malicious software in a communication network

(75) Inventors: James B. Bookbinder, Leander, TX (US); Jon Paden, Austin, TX (US); Antonio Green, Round Rock, TX (US); Dawn Steele, Georgetown, TX (US); Joe Garcia, Cedar Park, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/157,774

(22) Filed: Jun. 21, 2005

(51) Int. Cl. G06F 12/14

(52) U.S. Cl. 726/24

(57) ABSTRACT

A controller (104) manages operations of a communication network (101). The controller has a communication element (202) for monitoring data traffic in the communication network and for controlling operations of the communication network, a memory (204) for storage, and a processor (206) for controlling operations of the communication element, and the memory. The processor is programmed to monitor (302) the communication network for the effects of malicious software, detect (304) a suspected malicious event, record (306) the suspected malicious event, restrict (308) Internet access to one or more customers suspected of having infected terminal equipment interrupting service of the communication network, and notify (310) said one or more customers of the restricted Internet access.

### FIELD OF THE INVENTION

This invention relates generally to malicious software, and more particularly to a method and apparatus for mitigating the effects of malicious software in a communication network.

### BACKGROUND OF THE INVENTION

Malicious software such as viruses and worms has been known to create bot networks, cause spamming, and other destructive activities. A bot, also referred to as a remote-access Trojan program, seeks out and places itself on computers running silently in the background, thereby allowing the attacker to operate the computer while the owner is unaware. Such computers are generally referred to as zombies, which in the aggregate can be manipulated to cause havoc to communication networks by way of excessive message congestion along with furthering the spread of malicious software to other computers.

Many products have been developed to monitor and remove malicious software. Although these products have proven useful, they have failed to provide a holistic solution for protecting large communication networks and its customers.

### SUMMARY OF THE INVENTION

Embodiments in accordance with the invention provide a method and apparatus for mitigating the effects of malicious software in a communication network.

In a first embodiment of the present invention, a computer-readable storage medium manages a communication network. The storage medium has computer instructions for monitoring the communication network for the effects of malicious software, detecting a suspected malicious event, recording the suspected malicious event, restricting Internet access to one or more customers suspected of having infected terminal equipment interrupting service of the communication network, and notifying said one or more customers of the restricted Internet access.

In a second embodiment of the present invention, a controller manages operations of a communication network. The controller has a communication element for monitoring data traffic in the communication network and for controlling operations of the communication network, a memory for storage, and a processor for controlling operations of the communication element, and the memory. The processor is programmed to monitor the communication network for the effects of malicious software, detect a suspected malicious event, record the suspected malicious event, restrict Internet access to one or more customers suspected of having infected terminal equipment interrupting service of the communication network, and notify said one or more customers of the restricted Internet access.

In a third embodiment of the present invention, a controller manages a communication network according to a method. The method has the steps of monitoring the communication network for the effects of malicious software, detecting a suspected malicious event, recording the suspected malicious event, restricting Internet access to one or more customers suspected of having infected terminal equipment interrupting service of the communication network, notifying said one or more customers of the restricted Internet access, and providing said one or more customers with options to remove malicious software from their terminal equipment.

### BRIEF DESCRIPTION OF THE DRAWINGS

FIG. 1 is block diagram of a communication network according to an embodiment of the present invention;

FIG. 2 is block diagram of a controller managing the communication network according to an embodiment of the present invention; and

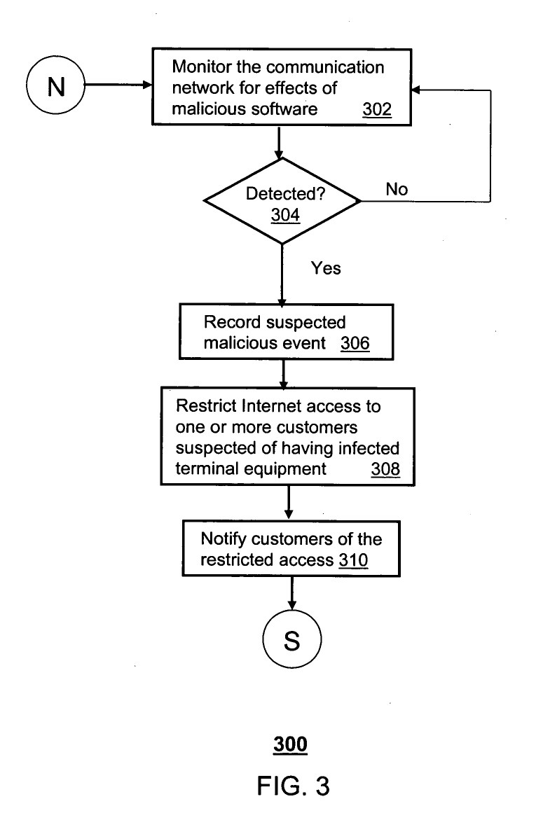

FIGS. 3-4 depict flowcharts of a method operating in the controller according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

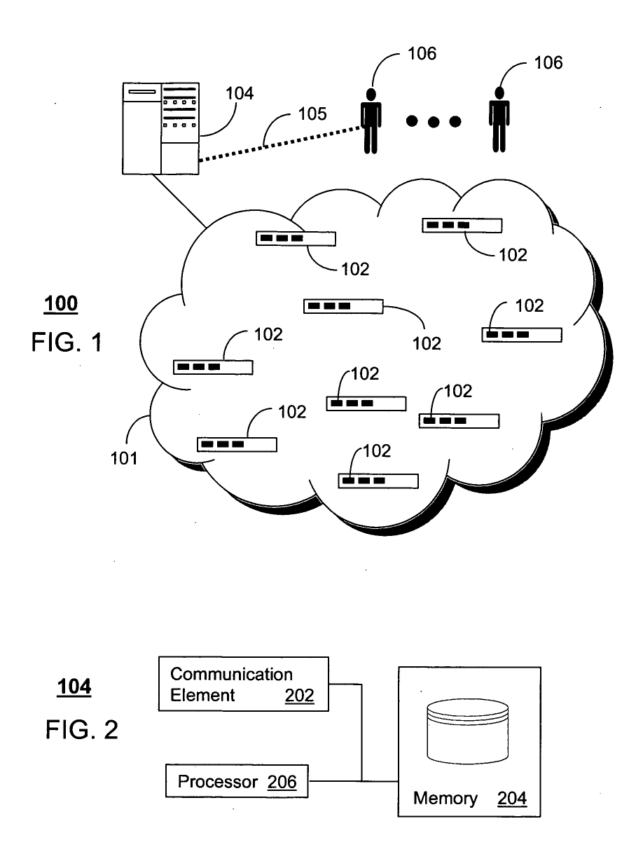

FIG. 1 is block diagram 100 of a communication network 101 according to an embodiment of the present invention. The communication network 101 includes a number of conventional network elements 102 for providing communication services to customers of the service provider of said network. The communication network 101 supports Internet services utilizing known (and future) technologies such as as IP (Internet Protocol), MPLS (multi-protocol label switching), FR/ATM (Frame Relay/Asynchronous Transfer Mode), just to mention a few. The network elements 102 of the communication network 101 are managed by a controller 104.

The controller 104 comprises a communication element 202, a memory 204, and a processor 206. The communication element 202 utilizes convention communication technology for monitoring data traffic in the communication network 101. Said element 202 can also be used for controlling operations of the network elements 102 of the communication network 101. The processor 206 can include one or more conventional computers or servers for controlling operations of the communication network 101. The memory 104 utilizes one or more conventional media devices (such as a high capacity disk drive, Flash memory, Dynamic Random Access Memory, Random Access Memory or other like memories) for storage purposes, and can be used for managing a database of a service provider of said communication network 101.

The controller 104 can have several embodiments including an IVR (Interactive Voice Response) system, a CRM (Customer Relationship Management) system, an ACD (Automatic Call Distributor) for routing customers to selected agents, and combinations thereof that operate according to the invention. These embodiments can also operate as independent entities located in multiple geographical sites cooperating amongst each other in accordance with the present invention. Additionally, the controller 106 can interact with customers of the communication network 101 by way of the IVR system and/or via an Internet web site, and can interconnect said customers with support personnel 106 serving as agents of the service provider of the communication network 101. These agents include customer support, technical support, or other specialized personnel employed by the service provider to support the methods of the present invention.

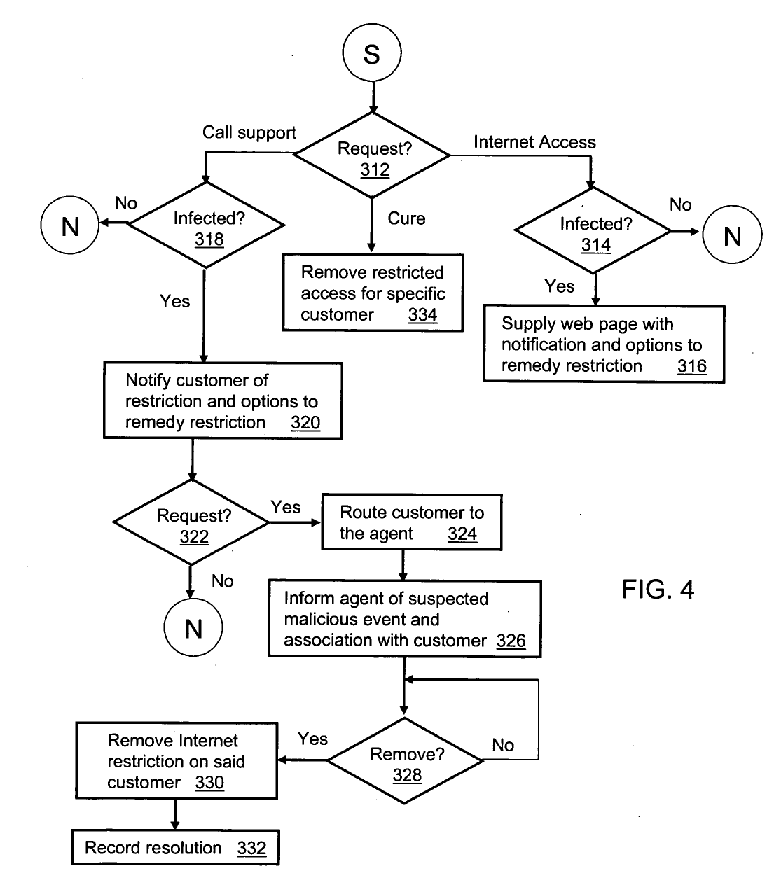

A function of the controller 104 is to mitigate the effects of malicious software in a communication network 101. FIGS. 3-4 depict flowcharts of a method 300 executing such purpose in the controller 104 according to an embodiment of the present invention. Method 300 begins with step 302 in which the controller 104 monitors the communication network 101 for the effects of malicious software such as viruses, worms or other classifications of software that are intended to harm, misappropriate, or cause harmful effects. This step can be performed with conventional software algorithms that monitor the communication network 101 for one or more customers suspected of having infected terminal equipment (e.g., PC, laptop, servers, etc.).

The controller 104 continues to search for infected customers until one or more are detected in step 304. Upon detecting an event in step 304, the controller proceeds to step 306 where it records in the CRM portion of the controller 104 the suspected malicious event. This recording can provide all systems of the communication network 101 that have access the controller 104 constructive notice of the event and details relating thereto (e.g., city, customers affected, suspected virus type, time of detection, etc.)

To avoid harm to the communication network 101 and its unaffected customers, the controller 104 in step 308 instructs the network elements 102 to restrict Internet access to those customers suspected of having infected terminal equipment. In step 310, these customers are notified of the restricted Internet access and are provided options to remedy the restriction. The notification step can be provided by email, or by an over-the-air message to a cell phone of the customer.

Method 300 continues in FIG. 4. In step 312, one of several requests can come from these alerted customers. In one instance, one or more of the affected customers can request access to the Internet after the restriction in step 308 has been established. The controller 104 processes this request by determining in step 314 from the CRM if the terminal equipment submitting the request is a source of the suspected malicious event. If not, the controller 104 allows the access and proceeds to step 302. Otherwise, the controller 104 supplies in step 316 a web page with notification of the restricted access and one or more options to remedy the suspected malicious software operating in the terminal equipment of the customer.

The options can include, but are not limited to, providing a selection of downloadable software solutions that the customer can acquire for free (or at a charge) to remove the suspected software virus, providing contact information for customer service support, and/or technical support, and accepting requests from the one or more customers to remove the restricted access on the basis of mitigation steps taken by said customers. Accordingly, a customer who initiates self-help actions by downloading virus protection software to remove the malicious software can subsequently submit a request in step 312 by way of this web page (or the IVR) to remove the restriction in step 334. In this step the controller 104 can remove the restriction on a probationary basis by observing future behaviors of said terminal equipment before completely removing the alert information recorded in the CRM.

Alternatively, the customer can call a support center of the service provider in step 312. In this embodiment, the IVR system of the controller 104 is used for interacting with the customer. The IVR in step 318 checks whether the calling customer has infected terminal equipment as recorded by the CRM. If it does not, then the IVR gracefully terminates the call with the customer and proceeds to step 302. If, however, the caller is a suspected customer with infected equipment, then the IVR proceeds to step 320 where it notifies the customer of the customer support and technical support centers available to assist her. In step 322 the customer can choose to forego such service, or proceed to routing the customer to a selected agent at step 324.

Depending on the expertise of the agent, the service may or may not be provided to the customer for free. The agent in turn is informed by the controller 104 by way of the CRM of the situation relating to the calling customer in step 326. The agent can proceed to assist the customer in remedying the infected terminal, or if further expertise is required, route the caller to other technical support personnel. If the malicious software is successfully removed in step 328, then the agent proceeds to step 330 where it instructs the controller 104 to remove the restricted access. Additionally, the agent further instructs the controller 104 to record in the CRM the resolution in step 332.

In the foregoing embodiments the term Internet should be construed loosely. That is, the present invention can be applied in any network independent of security boundaries (such as firewalls) installed by customers. The term Internet can therefore mean Intranet and Extranet. Thus, the present invention can be applied to any network element 102 manageable by the aforementioned controller 104.

It should be evident by now that the present invention can be realized in hardware, software, or a combination of hardware and software. Moreover, the present invention can be realized in a centralized fashion, or in a distributed fashion where different elements are spread across several interconnected processors. Any kind of computer device or other apparatus adapted for carrying out method 300 described above is suitable for the present invention.

Additionally, the present invention can be embedded in a computer program product, which comprises all the features enabling the implementation of method 300, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. For example, method 300 can be reduced to steps 302, 304, 306, 308 and 310 within the scope of the claimed invention. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium for managing a communication network, the storage medium comprising computer instructions for:
monitoring the communication network for the effects of malicious software;
detecting a suspected malicious event;
recording the suspected malicious event
restricting Internet access to one or more customers suspected of having infected terminal equipment interrupting service of the communication network; and
notifying said one or more customers of the restricted Internet access.

2. The storage medium of claim 1, comprising computer instructions for providing said one or more customers with options to remove malicious software from their terminal equipment.

3. The storage medium of claim 1, comprising computer instructions for:
receiving a request from terminal equipment of one of said customers to access the Internet;
determining if said terminal equipment is a source of the suspected malicious event; and
if so, supplying said terminal equipment an Internet web page with limited access to the communication network providing notification of the restricted access and one or more options to remedy the suspected malicious software operating in said terminal equipment.

4. The storage medium of claim 3, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.

5. The storage medium of claim 1, comprising computer instructions for:
receiving an indication from one of said customers that the suspected malicious software has been removed; and
removing the restricted access to the Internet for said customer.

6. The storage medium of claim 1, comprising computer instructions for:
receiving a call from one of said customers;
determining if the terminal equipment of the calling customer is a source of the suspected malicious event; and
notifying said customer of the restricted access and provide one or more options to remedy the suspected malicious software operating in the terminal equipment of said customer.

7. The storage medium of claim 6, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.

8. The storage medium of claim 6, comprising computer instructions for:
receiving a request from said customer for support from an agent of the communication network;
routing said customer to the agent;
informing the agent of the suspected malicious event and its association with said customer;
removing upon a request of the agent the restricted Internet access to said customer; and
recording that the suspected malicious event has been resolved for said customer.

9. A controller for managing operations of a communication network, the controller comprising:
a communication element for monitoring data traffic in the communication network and for controlling operations of the communication network;
a memory for storage; and
a processor for controlling operations of the communication element, and the memory, wherein the processor is programmed to:
monitor the communication network for the effects of malicious software;
detect a suspected malicious event;
record the suspected malicious event;
restrict Internet access to one or more customers suspected of having infected terminal equipment interrupting service of the communication network; and
notify said one or more customers of the restricted Internet access.

10. The controller of claim 9, wherein the processor is programmed to provide said one or more customers with options to remove malicious software from their terminal equipment.

11. The controller of claim 9, wherein the processor is programmed to:
receive a request from terminal equipment of one of said customers to access the Internet;
determine if said terminal equipment is a source of the suspected malicious event; and
if so, supply said terminal equipment an Internet web page with limited access to the communication network providing notification of the restricted access and one or more options to remedy the suspected malicious software operating in said terminal equipment.

12. The controller of claim 11, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.

13. The controller of claim 9, wherein the processor is programmed to:
receive an indication from one of said customers that the suspected malicious software has been removed; and
remove the restricted access to the Internet for said customer.

14. The controller of claim 9, wherein the processor is programmed to:
receive a call from one of said customers;
determine if the terminal equipment of the calling customer is a source of the suspected malicious event; and
notify said customer of the restricted access and provide one or more options to remedy the suspected malicious software operating in the terminal equipment of said customer.

15. The controller of claim 14, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.

16. The controller of claim 14, wherein the processor is programmed to:
receive a request from said customer for support from an agent of the communication network;
route said customer to the agent;
inform the agent of the suspected malicious event and its association with said customer;
remove upon a request of the agent the restricted Internet access to said customer; and
record that the suspected malicious event has been resolved for said customer.

17. In a controller that manages a communication network, a method comprising the steps of:
monitoring the communication network for the effects of malicious software;
detecting a suspected malicious event;
recording the suspected malicious event;
restricting Internet access to one or more customers suspected of having infected terminal equipment interrupting service of the communication network;
notifying said one or more customers of the restricted Internet access; and
providing said one or more customers with options to remove malicious software from their terminal equipment.

18. The method of claim 17, comprising the steps of:
receiving a request from terminal equipment of one of said customers to access the Internet;
determining if said terminal equipment is a source of the suspected malicious event; and
if so, supplying said terminal equipment an Internet web page with limited access to the communication network providing notification of the restricted access and one or more options to remedy the suspected malicious software operating in said terminal equipment, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.

19. The method of claim 17, comprising the steps of:
receiving an indication from one of said customers that the suspected malicious software has been removed; and
removing the restricted access to the Internet for said customer.

20. The method of claim 17, comprising the steps of:
receiving a call from one of said customers;
determining if the terminal equipment of the calling customer is a source of the suspected malicious event; and
notifying said customer of the restricted access and provide one or more options to remedy the suspected malicious software operating in the terminal equipment of said customer, wherein said options are at least one among a group of options comprising instructions for selecting one or more software solutions to remove the suspected malicious software from the infected terminal equipment of said customer, offering customer service support, offering technical support, and an option to accept requests from the one or more customers to remove the restricted access on the basis of mitigation steps taken by said customers.
